(19) United States
(12) Patent Application Publication
(10) Pub. No.: US 2017/0019892 A1
(43) Pub. Date: Jan. 19, 2017

(54) COMMUNICATION CONTROL METHOD, BASE STATION, AND USER TERMINAL

(71) Applicant: KYOCERA CORPORATION, Kyoto (JP)

(72) Inventors: Katsuhiro MITSUI, Kawasaki-shi (JP); Hiroyuki URABAYASHI, Yokohama-shi (JP); Kugo MORITA, Yokohama-shi (JP)

(73) Assignee: KYOCERA CORPORATION, Kyoto (JP)

(21) Appl. No.: 15/281,685

(22) Filed: Sep. 30, 2016

Related U.S. Application Data
(63) Continuation of application No. PCT/JP2015/063378, filed on May 8, 2015.

(30) Foreign Application Priority Data
May 9, 2014 (JP) 2014-097519

(51) Int. Cl. H04W 72/04; H04W 52/02; H04W 24/10

(52) U.S. Cl. CPC H04W 72/0406; H04W 24/10; H04W 52/0206; H04W 72/042

(57) ABSTRACT

A communication control method comprising: setting at least part of downlink radio resources available in a first cell to a first resource at a first base station, wherein the first base station is configured to manage the first cell connected to a user terminal and restricts transmission in the first resource; sending information from the first base station to the user terminal, wherein the information indicates the first resource; performing measurement of received power and/or reception quality of a reference signal at the user terminal, wherein a second cell transmits the reference signal with using the first resource; transmitting a measurement report from the user terminal to the first base station, wherein the measurement report includes a result of the measurement; and determining whether or not the first cell is settable to a switch off mode, on the basis of the measurement report, at the first base station, wherein the switch off mode includes stopping the first cell from transmitting a signal.

### CROSS-REFERENCE TO RELATED APPLICATION

The present application is a continuation in part based on PCT Application No. PCT/JP2015/063378 filed on May 8, 2015, which claims the benefit of Japanese Application No. 2014-097519, filed on May 9, 2014. PCT Application No. PCT/JP2015/063378 is entitled “COMMUNICATION CONTROL METHOD, BASE STATION AND USER TERMINAL”, and Japanese Application No. 2014-097519 is entitled “COMMUNICATION CONTROL METHOD, BASE STATION AND USER TERMINAL”. The content of which is incorporated by reference herein in their entirety.

### FIELD

An embodiment of the present disclosure relates to a communication control method, a base station, and a user terminal, used in a mobile communication system.

### BACKGROUND

3GPP (3rd Generation Partnership Project), which is a project aiming to standardize a mobile communication system, moves forward with preparation of a specification regarding an energy saving technology for saving energy in a base station.

The energy saving technology may include, when there are a first base station configured to form a target cell and a second base station configured to form a neighboring cell adjacent the target cell, setting the target cell to a switch off mode.

There is a technique of utilizing a measurement report transmitted from the user terminal in order for the base station to set the target cell to the switch off mode after confirming that the cell is covered by the neighboring cell. Specifically, on the basis of whether the measurement report transmitted from the user terminal connected to the target cell includes a good measurement result for a reference signal transmitted by the neighboring cell, the base station determines whether or not the target cell is covered by the neighboring cell.

### SUMMARY

Disclosed is a communication control method for appropriately determining whether or not a target cell is settable to a switch off mode. Also, a base station therefor, and a user terminal therefor are disclosed.

In an embodiment, the communication control method comprises setting at least part of downlink radio resources available in a first cell to a first resource at a first base station, wherein the first base station is configured to manage the first cell connected to a user terminal and restricts transmission in the first resource. The communication control method further includes sending information from the first base station to the user terminal, wherein the information indicates the first resource. The communication control method further includes performing measurement of received power and/or reception quality of a reference signal at the user terminal, wherein a second cell transmits the reference signal with using the first resource. The communication control method further includes transmitting a measurement report from the user terminal to the first base station, wherein the measurement report includes a result of the measurement. The communication control method further includes determining whether or not the first cell is settable to a switch off mode, on the basis of the measurement report, at the first base station. The switch off mode includes suspension of the first cell from transmitting a signal.

In an embodiment, the base station is for managing a first cell connected to a user terminal. The base station comprises a controller and a receiver. The controller is configured to set part of downlink radio resources available in the first cell to a first resource in which the base station restricts transmission. The controller is configured to send information to the user terminal, wherein the information indicates the first resource. The receiver is configured to receive, from the user terminal, a measurement report including a result of measurement of the received power and/or the reception quality of a reference signal, wherein the reference signal is transmitted by a second cell with using the first resource. The controller is further configured to determine, on the basis of the measurement report, whether or not the first cell is settable to a switch off mode. The switch off mode includes stopping the first cell from transmitting a signal.

In an embodiment, the user terminal is configured to connect to a first cell managed by a base station. The user terminal comprises a controller and a transmitter. The controller is configured to perform measurement of the received power and/or the reception quality of a reference signal with using a first resource if receiving information indicating the first resource from the base station, wherein the reference signal is transmitted by a second cell with using the first resource. The transmitter is configured to transmit a measurement report to the base station, wherein the measurement report includes a result of the measurement. The first resource comprises a downlink radio resource in which the base station restricts transmission. The switch off mode includes stopping the first cell from transmitting a signal.

In an embodiment, the communication control method comprises stopping, at a first base station, a first cell from transmitting a signal for a certain period of time, wherein the first base station is configured to manage the first cell connected to a user terminal. The communication control method further includes detecting, at the user terminal, a failure of a radio link with the first cell. The communication control method further includes transmitting a report on the failure from the user terminal to the first base station if the radio link is recovered after an elapse of the certain period of time. The communication control method further includes determining, at the first base station, on the basis of the report, whether or not the first cell is settable to a switch off mode. The switch off mode includes that stopping the first cell from transmitting a signal.

### BRIEF DESCRIPTION OF THE DRAWINGS

FIG. 1 is a configuration diagram of an LTE system according to one or more embodiments.

FIG. 2 is a block diagram of a UE according to one or more embodiments.

FIG. 3 is a block diagram of an eNB according to one or more embodiments.

FIG. 4 is a protocol stack diagram of a radio interface according to one or more embodiments.

FIG. 5 is a configuration diagram of a radio frame used in the LTE system according to one or more embodiments.

FIG. 6 is a diagram showing an operation environment according to one or more embodiments.

FIGS. 7(a) and 7(b) are diagrams for describing a transmission regulation resource according to an embodiment.

FIG. 8 is a flowchart showing a UE selection operation according to an embodiment.

FIG. 9 is a sequence diagram showing an operation sequence according to an embodiment.

FIG. 10 is a sequence diagram showing an operation sequence according to an embodiment.

FIG. 11 is a diagram for describing a transmission regulation resource according to an embodiment.

FIG. 12 is a sequence diagram showing an operation sequence according to an embodiment.

FIG. 13 is a diagram showing an operation environment according to an embodiment.

### DETAILED DESCRIPTION

Hereinafter, embodiments of present disclosure when apply the present disclosure to a LTE system which is a mobile communication system based on 3GPP standard as an example, will be explained.

### System Configuration

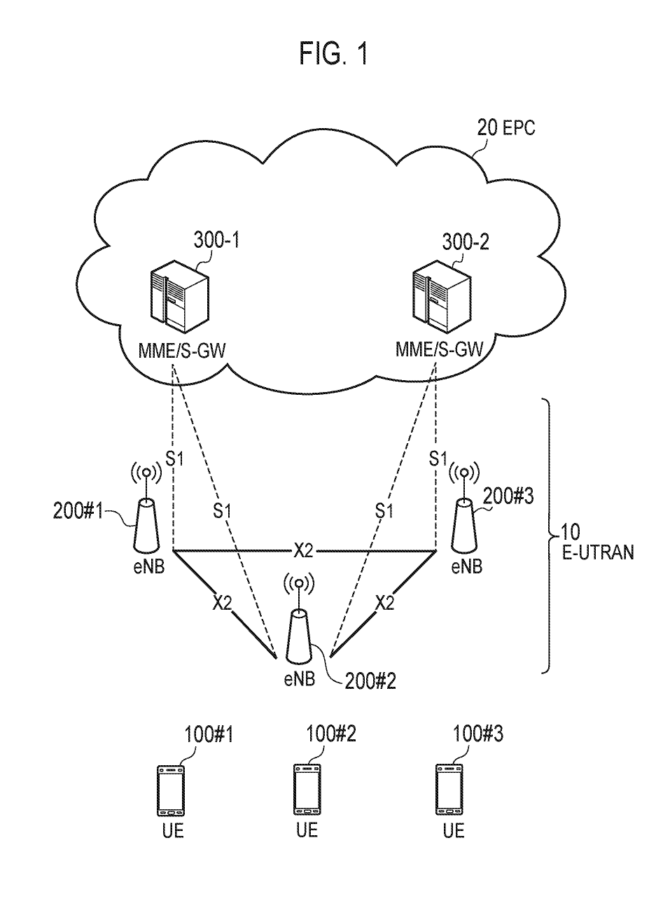

Firstly, the configuration of the LTE system according to one or more embodiments will be described. FIG. 1 is a configuration diagram of the LTE system according to one or more embodiments.

As shown in FIG. 1, the LTE system according to one or more embodiments may include UEs (User Equipments) 100, E-UTRAN (Evolved-UMTS Terrestrial Radio Access Network) 10, and EPC (Evolved Packet Core) 20.

The UE 100 may be a user terminal. The UE 100 is a mobile communication device and can perform radio communication with a cell (a serving cell).

The E-UTRAN 10 may be a radio access network. The E-UTRAN 10 includes eNBs 200 (evolved Node-Bs). The eNB 200 may be a base station. The eNBs 200 are connected mutually via an X2 interface. In the present disclosure, the connection includes, without limitation, a wired connection or a wireless connection, the same may apply hereafter.

The eNB 200 may manage one or more cells and performs radio communication with the UE 100 that establishes a connection with the cell of the eNB 200. The eNB 200, for example, has a radio resource management (RRM) function, a function of routing user data, and a measurement control function for mobility control and scheduling. It is noted that the “cell” may indicate a minimum unit of a radio communication area, and also indicate a function of performing radio communication with the UE 100.

The EPC 20 may be a core network. The EPC 20 includes MME (Mobility Management Entity)/S-GW (Serving-Gateway) 300. The MME performs various mobility controls and the like, for the UE 100. The S-GW performs control to transfer user data. The MME/S-GW 300 connects to the eNB 200 via an S1 interface. Moreover, the E-UTRAN 10 and the EPC 20 constitute a network of the LTE system.

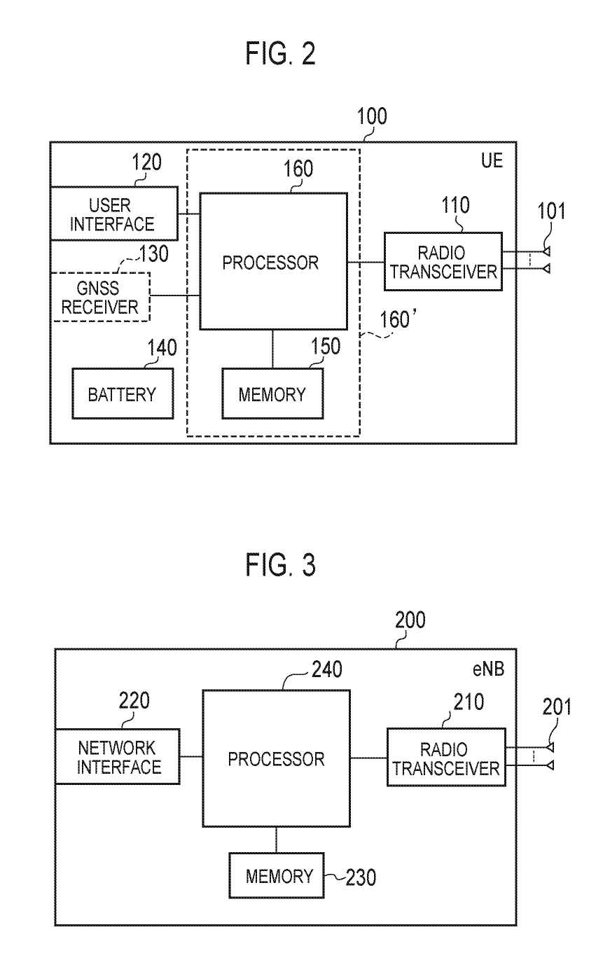

FIG. 2 is a block diagram of the UE 100 according to an embodiment. As shown in FIG. 2, the UE 100 may include plural antennas 101, a radio transceiver 110, a user interface 120, GNSS (Global Navigation Satellite System) receiver 130, a battery 140, a memory 150, and a processor 160. The memory 150 and the processor 160 may be a controller. The radio transceiver 110 and the processor 160 may be a transmitter and a receiver. The UE 100 may not have the GNSS receiver 130. Furthermore, the memory 150 may be integrally formed with the processor 160, and this set (that is, a chip set) may be a processor 160′.

The antenna 101 and the radio transceiver 110 are used to transmit and receive a radio signal. The radio transceiver 110 converts a baseband signal (a transmission signal) output from the processor 160 into the radio signal, and transmits the radio signal from the antenna 101. Furthermore, the radio transceiver 110 converts a radio signal (a reception signal) received by the antenna 101 into the baseband signal, and outputs the baseband signal to the processor 160.

The user interface 120 is an interface with a user carrying the UE 100, and includes, for example, a display, a microphone, a speaker, various buttons and the like. The user interface 120 receives an operation from a user and outputs a signal indicating the content of the operation to the processor 160. The GNSS receiver 130 receives a GNSS signal in order to obtain location information indicating a geographical location of the UE 100, and outputs the received GNSS signal to the processor 160. The battery 140 accumulates a power to be supplied to each block of the UE 100. The memory 150 stores a program to be executed by the processor 160 and information to be used for a process by the processor 160. The processor 160 includes a baseband processor that performs modulation and demodulation, encoding and decoding and the like on the baseband signal, and a CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As shown in FIG. 3, the eNB 200 includes plural antennas 201, a radio transceiver 210, a network interface 220, a memory 230, and a processor 240. The memory 230 and the processor 240 constitute a controller. The radio transceiver 210 (and/or the network interface 220) and the processor 240 constitute a transmitter and a receiver. Moreover, the memory 230 may be integrated with the processor 240, and this set (that is, a chipset) may be a processor.

The antennas 201 and the radio transceiver 210 are used to transmit and receive a radio signal. The radio transceiver 210 converts a baseband signal (a transmission signal) output from the processor 240 into the radio signal, and transmits the radio signal from the antenna 201. Furthermore, the radio transceiver 210 converts a radio signal (a reception signal) received by the antenna 201 into the baseband signal, and outputs the baseband signal to the processor 240.

The network interface 220 is connected to the neighbor eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240. The processor 240 includes the baseband processor that performs modulation and demodulation, encoding and decoding and the like on the baseband signal and a CPU that performs various processes by executing the program stored in the memory 230. The processor 240 executes various processes and various communication protocols described later.

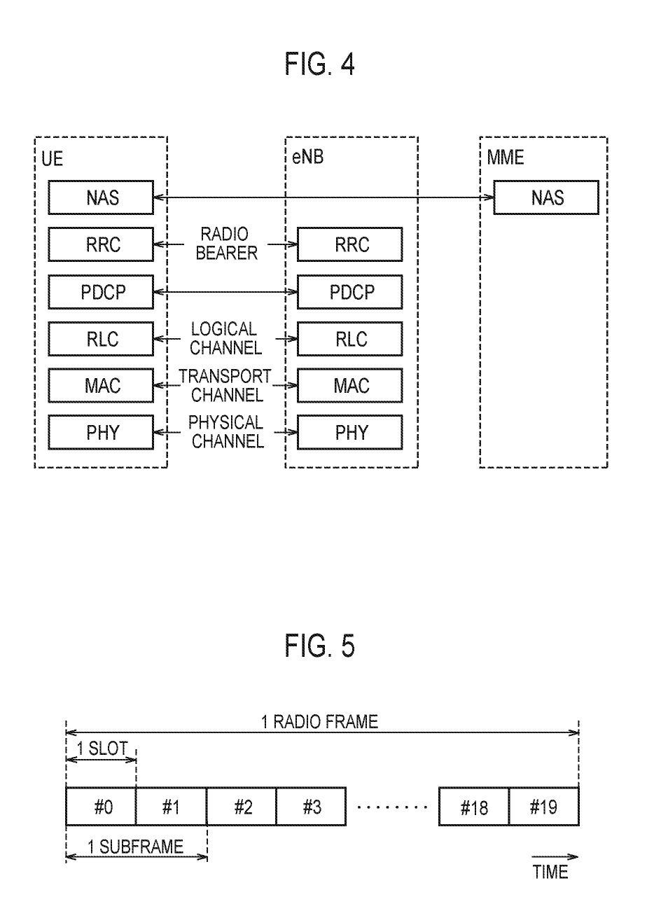

FIG. 4 is a protocol stack diagram of a radio interface in the LTE system. As shown in FIG. 4, the radio interface protocol is divided into a layer 1 to a layer 3 of an OSI reference model, wherein the layer 1 is a physical (PHY) layer. The layer 2 includes MAC (Medium Access Control) layer, RLC (Radio Link Control) layer, and PDCP (Packet Data Convergence Protocol) layer. The layer 3 includes RRC (Radio Resource Control) layer.

The PHY layer is capable of performing encoding and decoding, modulation and demodulation, antenna mapping and demapping, and resource mapping and demapping. Between the PHY layer of the UE 100 and the PHY layer of the eNB 200, user data and a control information are transmitted through the physical channel.

The MAC layer is capable of performing priority control of data, a retransmission process by hybrid ARQ (HARQ), and a random access procedure and the like. Between the MAC layer of the UE 100 and the MAC layer of the eNB 200, user data and a control information are transmitted via a transport channel. The MAC layer of the eNB 200 includes a transport format of an uplink and a downlink (a transport block size, a modulation and coding scheme (MCS)) and a scheduler to decide an allocated resource block to the UE 100.

The RLC layer transmits data to an RLC layer of a reception side by using the functions of the MAC layer and the PHY layer. Between the RLC layer of the UE 100 and the RLC layer of the eNB 200, user data and a control information are transmitted via a logical channel.

The PDCP layer performs header compression and decompression, and encryption and decryption.

The RRC layer is defined only in a control plane handling a control information. Between the RRC layer of the UE 100 and the RRC layer of the eNB 200, a control information (an RRC message) for various types of setting is transmitted. The RRC layer controls the logical channel, the transport channel, and the physical channel in response to establishment, re-establishment, and release of a radio bearer. When a connection (an RRC connection) is established over the RRC layer between the RRC of the UE 100 and the RRC of the eNB 200, the UE 100 is in an RRC connected state, otherwise, the UE 100 is in an RRC idle state.

NAS (Non-Access Stratum) layer positioned above the RRC layer performs session management, mobility management and the like.

FIG. 5 is a configuration diagram of a radio frame used in the LTE system. In the LTE system, OFDMA (Orthogonal Frequency Division Multiple Access) is used in a downlink, and SC-FDMA (Single Carrier Frequency Division Multiple Access) is used in an uplink, respectively.

As shown in FIG. 5, the radio frame has 10 subframes arranged in a time direction. Each subframe has two slots arranged in the time direction. Each subframe has a length of 1 ms and each slot has a length of 0.5 ms. Each subframe includes a plurality of resource blocks (RBs) in a frequency direction, and a plurality of symbols in the time direction. Each resource block includes a plurality of subcarriers in the frequency direction. A resource element (RE) is configured by one subcarrier and one symbol. Moreover, among radio resources (time-frequency resources) allocated to the UE 100, a frequency resource is specified by a resource block and a time resource is specified by a subframe (or slot).

In the downlink, an interval of several symbols at the head of each subframe is a control region used as a physical downlink control channel (PDCCH) for mainly transmitting control information. Furthermore, the other interval of each subframe is a data region available as a physical downlink shared channel (PDSCH) for mainly transmitting user data.

In the downlink, each subframe is provided with a plurality of cell-specific reference signals (CRSs) distributed in the frequency direction and the time direction. Specifically, the CRSs are provided, at intervals of six subcarriers, in a first OFDM symbol and a third OFDM symbol from the last, respectively, in a slot. A signal sequence of the CRS is made to correspond to a physical cell identifier (PCI). Further, the frequency position of the CRS is determined in accordance with the PCI.

### Operation Environment and Energy Saving Technology

An operation environment and an energy saving technology according to one or more embodiments will be described, below.

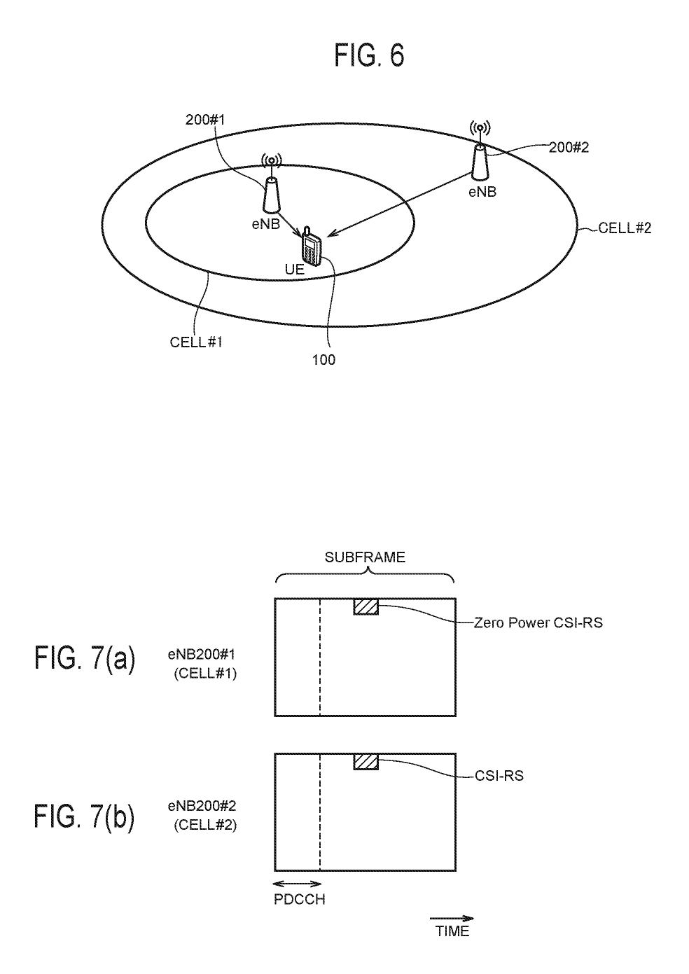

FIG. 6 is a diagram showing the operation environment according to one or more embodiments.

As shown in FIG. 6, an eNB 200 #1 (first base station) manages a cell #1, and an eNB 200 #2 (second base station) manages a cell #2. A coverage of the cell #1 is narrower than a coverage of the cell #2. In one or more embodiments, the cell #2 is a macro cell and the cell #1 is a small cell (a pico cell or a femto cell, for example). The cell #1 is located within the coverage of the cell #2.

On the basis of the cell #1, the cell #2 is a neighboring cell of the cell #1. The UE 100 is in a state of being connected to the cell #1 (RRC connected state).

In one or more embodiments, a case is assumed where the cell #1 and the cell #2 belong to the same frequency. Further, a case is also assumed where the cell #1 and the cell #2 are synchronized.

The energy saving technology enables reduction of a power consumed in the eNB 200 #1 by setting the cell #1 to a switch off mode, in an operation environment as shown in FIG. 6. The switch off mode is a mode in which transmission of all the downlink radio signals from at least the cell #1 is switched off (off-the-air). Here, in order to prevent generation of a coverage hole, it is necessary that the coverage of the cell #1 which is set to the switch off mode is covered by the cell #2.

In one or more embodiments, in order for the eNB 200 #1 to set the cell #1 to the switch off mode after confirming that the cell #1 is covered by the cell #2, the eNB 200 #1 utilizes a measurement report transmitted from the UE 100. Specifically, on the basis of whether the measurement report transmitted from the UE 100 connected to the cell #1 includes a good measurement result for a reference signal of the cell #2, the eNB 200 #1 determines whether or not the cell #1 is covered by the cell #2. The reference signal of the cell #2 may be a reference signal transmitted from the cell #2, the same may apply hereafter. The measurement result is a reference signal received power (RSRP) or a reference signal received quality (RSRQ).

As a result, the eNB 200 #1 can prevent the cell #1 from being set to the switch off mode if the coverage of the cell #1 includes a coverage hole of the cell #2. No radio transmitted from the cell #2 can reach the coverage hole.

However, when the UE 100 is located adjacent to the eNB 200 #1, the reference signal of the cell #2 receives a strong interference from the cell #1. In such a case, the UE 100 finds it difficult to measure the reference signal of the cell #2. In other words, at a position (position adjacent to the eNB 200 #1) at which a strong interference is received from the cell #1, it is difficult to determine whether or not the cell #1 is covered by the cell #2.

### Communication Control Method According to One or More Embodiments

A communication control method according to one or more embodiments will be described, below. The communication control method according to one or more embodiments is a method for appropriately determining by using the measurement report whether or not the target cell (cell #1) is settable to the switch off mode.

The communication control method according to one or more embodiments is used in an operation environment as shown in FIG. 6. The eNB 200 #1 sets a part of a downlink radio resource in the cell #1 as a transmission regulation resource used for regulating the transmission from the eNB 200 #1 and notifies the UE 100 of the transmission regulation resource. It is noted that the eNB 200 #1 may restrict or prohibit the transmission of a signal in the transmission regulation resource, hereinafter, the same may apply. Next, the UE 100 measures the reference signal of the cell #2, in the notified transmission regulation resource, and transmits a specific measurement report on the measurement result to the eNB 200 #1. Then, the eNB 200 #1 determines on the basis of the specific measurement report whether or not the cell #1 is settable to the switch off mode.

In the transmission regulation resource in which the transmission from the eNB 200 #1 is regulated, even when the UE 100 is located near the eNB 200 #1, the UE 100 is capable of averting a strong interference from the cell #1. Therefore, when performing the measurement on the reference signal of the cell #2 in the transmission regulation resource, the UE 100 is capable of appropriately performing the measurement on the reference signal of the cell #2. As a result, the eNB 200 #1 is capable of more surely confirming whether or not the cell #1 is covered by the cell #2.

In one or more embodiments, the eNB 200 #1 selects, on the basis of the measurement report transmitted from each of a plurality of UEs 100 connected to the cell #1, a UE 100 not capable of measuring the reference signal of the cell #2, from among the plurality of UEs 100. Here, not being capable of measuring the reference signal of the cell #2 includes not being capable of obtaining a good measurement result about the cell #2. The eNB 200 #1 notifies the selected UE 100 of the transmission regulation resource. It is noted that not being capable of obtaining a good measurement result means that the measurement result about the cell #2 is equal to or less than a threshold value, for example.

The UE 100 not capable of measuring the reference signal of the cell #2 is a UE 100 located outside the coverage of the cell #2 or a UE 100 that receives a strong interference from the cell #1. Thus, when the eNB 200 #1 notifies such a UE 100 of the transmission regulation resource, it is possible to cause the UE 100 to exclude the influence of the interference from the cell #1 and to perform the measurement on the reference signal of the cell #2. Further, as compared to a case where the transmission regulation resource is notified to all UEs 100 connected to the cell #1, it is possible to save a radio resource and a process load of the eNB 200 #1.

When a specific measurement report transmitted from the UE 100 includes a good measurement result on the reference signal of the cell #2, the eNB 200 #1 determines that the cell #1 is settable to the switch off mode. On the other hand, when a specific measurement report does not include a good measurement result on the reference signal of the cell #2, the eNB 200 #1 determines that the cell #1 is not settable to the switch off mode.

### Transmission Regulation Resource According to an Embodiment

The transmission regulation resource according to an embodiment will be described, below.

In an embodiment, the transmission regulation resource is a resource element used for transmission of a CSI (Channel State Information) reference signal. The eNB 200 #1 sets transmission power of the CSI reference signal in the transmission regulation resource, to zero. Further, the eNB 200 #1 transmits configuration information on the transmission regulation resource to the eNB 200 #2. The eNB 200 #2 transmits, on the basis of the configuration information, the CSI reference signal in the transmission regulation resource. The UE 100 performs measurement on the CSI reference signal of the cell #2.

The CSI reference signal (CSI-RS) is a reference signal for measuring CSI in a MIMO transmission or the like. The CSI includes a CQI (Channel Quality Indicator) and the like. The CSI reference signal is set in a longer cycle as compared to the cell-specific reference signal. In an embodiment, such a CSI reference signal is utilized for measurement of RSRP/RSRQ, rather than the measurement of CSI.

FIGS. 7(a) and 7(b) are diagrams for describing the transmission regulation resource according to an embodiment.

As shown in FIG. 7(a), the eNB 200 #1 secures some resource elements in the cell #1, for transmission of the CSI reference signal. FIG. 7(a) shows a case, as an example, where a resource element of a PDSCH region in the downlink subframe is secured. Further, the eNB 200 #1 sets the transmission power of the CSI reference signal in the secured resource element, to zero. Such a CSI reference signal is called “Zero Power CSI-RS”, below.

In an embodiment, when the transmission regulation resource is set in each resource element, it is possible to reduce a decrease in throughput on transmission of a signal in the eNB 200 #1, as compared to a case where a whole of the subframe is set as the transmission regulation resource. It is noted that a case where a whole of the subframe is set as the transmission regulation resource will be described in an embodiment and another embodiment.

The eNB 200 #1 notifies the UE 100 and the eNB 200 #2 of the resource element to which the Zero Power CSI-RS is set.

As shown in FIG. 7(b), the eNB 200 #2 secures, for transmission of the CSI reference signal, the same resource element as the resource element secured by the eNB 200 #1, and transmits the CSI reference signal in the secured resource element.

The UE 100 measures, in the resource element notified from the eNB 200 #1, the RSRP/RSRQ of the CSI reference signal of the cell #2 (CSI reference signal transmitted from the cell #2, hereinafter, the same applies) of the CSI reference signal of the cell #2. Then, the UE 100 transmits, to the eNB 200 #1, a specific measurement report including a measurement report (RSRP/RSRQ).

### Specific Operation Example According to an Embodiment

A specific operation example according to an embodiment will be described, below.

### Selection Operation of UE 100

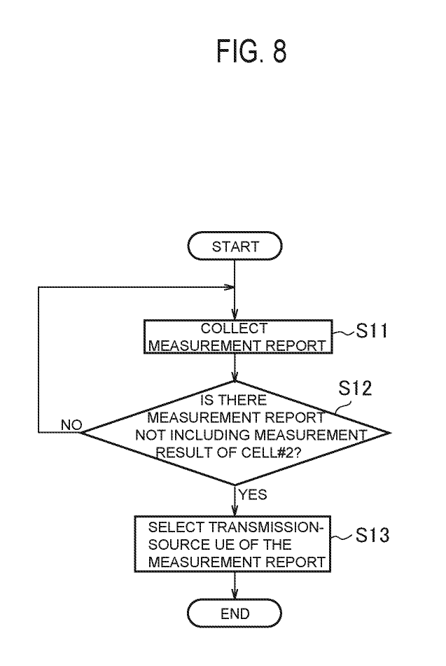

FIG. 8 is a flowchart showing a selection operation of the UE 100 not capable of measuring the reference signal of the cell #2, according to an embodiment. By the time to implement the present flow, the transmission regulation resource may not have been set.

As shown in FIG. 8, in step S11, the eNB 200 #1 collects, in a certain period, the measurement reports transmitted from each of the plurality of UEs 100 connected to the cell #1. The “certain period” is a time period during which a sufficient amount of measurement reports is obtained, and is determined by an operator. The “sufficient amount of measurement reports being obtained” indicates that the sufficient measurement reports by which the coverage area is covered are collected. The eNB 200 #1 confirms whether or not the measurement result (RSRP/RSRQ) of the cell #2 is included in each measurement report. It is noted that the measurement result of the cell #2 may be a result obtained when the UE 100 measures the RSRP/RSRQ of the CSI reference signal transmitted from the cell #2, and hereinafter, the same applies.

In step S12, the eNB 200 #1 determines whether or not there is a measurement report not including the measurement result (RSRP/RSRQ) of the cell #2. The eNB 200 #1 returns the process to step S11 when there is no measurement report not including the measurement result of the cell #2 (step S12: NO).

On the other hand, when there is a measurement report not including the measurement result of the cell #2 (step S12: YES), in step S13, the eNB 200 #1 selects the UE 100 that has transmitted, to the eNB 200 #1, the measurement report not including the measurement result of the cell #2. It is noted that the measurement report not including the measurement result of the cell #2 may be a measurement report including a not good measurement result of the cell #2. It is noted that the not good measurement result of the cell #2 may mean that the measurement result for the cell #2 is equal to or less than a threshold value.

It is noted that in FIG. 8, the eNB 200 #1 collectively performs the determination in step S12, on a plurality of measurement reports obtained in step S11. However, the eNB 200 #1 may perform, upon each receipt of the measurement report in step S11, the determination in step S12 on the measurement report only. In the pattern where the determination is made each time, the flow in FIG. 8 is performed during the “certain period”.

### Operation Sequence

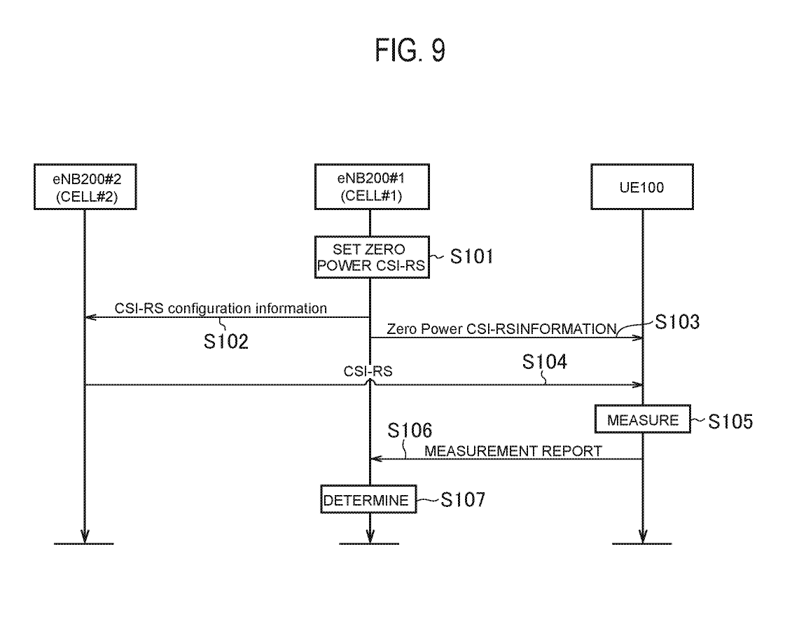

FIG. 9 is a sequence diagram showing an operation sequence according to an embodiment. The UE 100 in FIG. 9 is the UE 100 selected by using the operation flow in FIG. 8.

As shown in FIG. 9, in step S101, the eNB 200 #1 sets some resource elements in the cell #1 as the transmission regulation resource used for regulating the transmission from the eNB 200 #1. Specifically, the eNB 200 #1 sets the transmission power of the CSI reference signal in the resource elements, to zero.

In step S102, the eNB 200 #1 transmits to the eNB 200 #2 the CSI-RS configuration information that is configuration information on the CSI reference signal (Zero Power CSI-RS) of which the transmission power is rendered zero. The CSI-RS configuration information may be an information element of an X2 message. The CSI-RS configuration information may be regarded as request information for requesting the eNB 200 #2 to transmit the CSI reference signal. The CSI-RS configuration information includes information indicating the resource element set in step S101. The information may include at least one of subframe information, symbol information, and subcarrier information corresponding to the Zero Power CSI-RS. Further, the CSI-RS configuration information may include system information for specifying the CSI-RS transmitted by the eNB 200 #2 (cell #2).

In step S103, the eNB 200 #1 transmits, to the UE 100, Zero Power CSI-RS information that is configuration information on the CSI reference signal (Zero Power CSI-RS). The Zero Power CSI-RS information may be an information element of the RRC message. The Zero Power CSI-RS information may be regarded as request information for requesting the UE 100 to measure the CSI reference signal of the cell #2. The Zero Power CSI-RS information includes information indicating the resource element set by the eNB 200 #1 in step S101. The information may include at least one of the subframe information, the symbol information, and the subcarrier information corresponding to the Zero Power CSI-RS. The Zero Power CSI-RS information may include a cell ID of a cell to be measured (that is, the cell #2).

In step S104, the eNB 200 #2 transmits, on the basis of the CSI-RS configuration information received in step S102, the CSI reference signal (CSI-RS) in the same resource element as the resource element of the Zero Power CSI-RS.

In step S105, the UE 100 measures, on the basis of the Zero Power CSI-RS information received in step S103, the RSRP/RSRQ of the CSI-RS transmitted from the eNB 200 #2 (cell #2).

In step S106, the UE 100 transmits, to the eNB 200 #1, the measurement report (specific measurement report) including the measurement result (RSRP/RSRQ) measured in step S105. The specific measurement report may be the information element of the RRC message.

In step S107, the eNB 200 #1 determines, on the basis of the specific measurement report received in step S106, whether or not the cell #1 is settable to the switch off mode. When the specific measurement report includes a good measurement result (RSRP/RSRQ) of the cell #2, the eNB 200 #1 determines that the cell #1 is settable to the switch off mode. On the other hand, when the specific measurement report does not include a good measurement result (RSRP/RSRQ) of the cell #2, the eNB 200 #1 determines that the cell #1 is not settable to the switch off mode.

In an embodiment, the resource element of the Zero Power CSI-RS is determined by the eNB 200 #1; however, the resource element of the Zero Power CSI-RS may be determined by the eNB 200 #2.

When the resource element of the Zero Power CSI-RS is determined by the eNB 200 #2, the eNB 200 #2 transmits the CSI-RS configuration information to the eNB 200 #1. The eNB 200 #1 sets the resource element of the Zero Power CSI-RS to the cell #1, on the basis of the CSI-RS configuration information received from the eNB 200 #2.

### Transmission Regulation Resource According to an Embodiment

The transmission regulation resource according to an embodiment will be described, below.

In an embodiment, the transmission regulation resource is an almost blank subframe (ABS) in which the transmission of downlink user data is regulated. The ABS is introduced from the 3GPP Release 10, and sets a substantially blank downlink subframe to avoid the inter-cell interference.

It is noted that in order to ensure backward compatibility between the 3GPP Releases 8 and 9, in the ABS, a necessary control channel and physical signal, and system information are transmitted from a cell. Therefore, even to the cell in which the ABS is set, it is possible to connect a legacy UE.

In an embodiment, the eNB 200 #1 sets, as the ABS, some downlink subframes out of a plurality of downlink subframes. The UE 100 measures the cell-specific reference signal (CRS) of the eNB 200 #2 (cell #2), in the ABS. It is noted that that the cell-specific reference signal of the eNB 200 #2 (cell #2) may be a cell-specific reference signal transmitted from the eNB 200 #2 (cell #2), hereinafter, the same applies.

### Specific Example of Operation According to an Embodiment

A specific operation example according to an embodiment will be described, below. In an embodiment, an operation of selecting the UE 100 not capable of measuring the reference signal of the cell #2 (see FIG. 8) is similar to that in an embodiment.

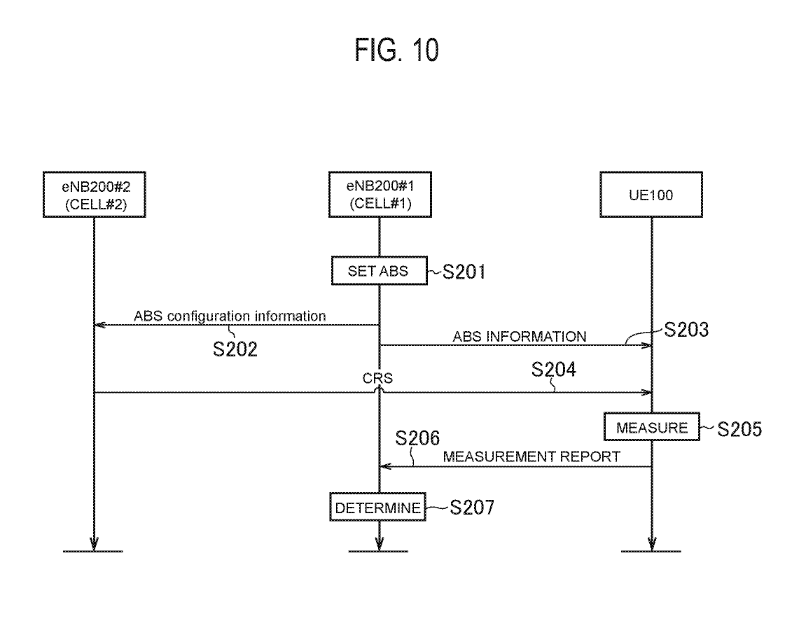

FIG. 10 is a sequence diagram showing an operation sequence according to an embodiment. The UE 100 in FIG. 10 is a UE 100 selected by using the operation flow in FIG. 8.

As shown in FIG. 10, in step S201, the eNB 200 #1 sets, as the ABS, some downlink subframes in the cell #1.

In step S202, the eNB 200 #1 transmits, to the eNB 200 #2, ABS configuration information that is configuration information on the ABS. The ABS configuration information may be an information element of an X2 message. However, step S202 is not essential; the eNB 200 #1 may omit step S202.

In step S203, the eNB 200 #1 transmits the ABS information that is the configuration information on the ABS, to the UE 100. The ABS information may be an information element of the RRC message. The ABS information may be regarded as the request information for requesting the UE 100 to measure the CRS of the cell #2. The ABS information includes information (subframe information) indicating the ABS set by the eNB 200 #1 in step S201.

In step S204, the eNB 200 #2 transmits the CRS.

In step S205, the UE 100 measures, on the basis of the ABS information received in step S203, the RSRP/RSRQ of the CRS transmitted from the eNB 200 #2 (cell #2).

In step S206, the UE 100 transmits the measurement report (specific measurement report) including the RSRP/RSRQ measured in step S205, to the eNB 200 #1. The specific measurement report may be the information element of the RRC message.

In step S207, the eNB 200 #1 determines, on the basis of the specific measurement report received from the UE 100, whether or not the cell #1 is settable to the switch off mode. When the specific measurement report includes a good RSRP/RSRQ for the CRS transmitted from the cell #2, the eNB 200 #1 determines that the cell #1 is settable to the switch off mode. On the other hand, when the specific measurement report does not include a good RSRP/RSRQ for the CRS transmitted from the cell #2, the eNB 200 #1 determines that the cell #1 is not settable to the switch off mode.

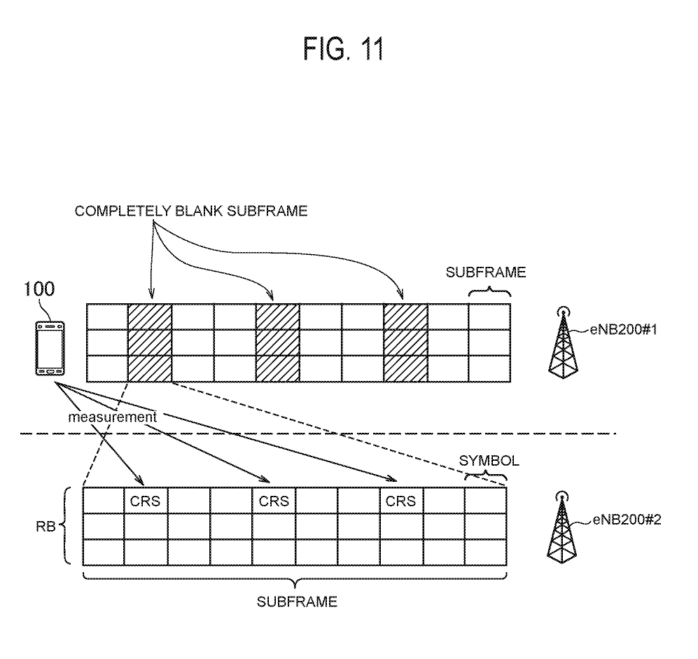

FIG. 11 is a diagram for describing the transmission regulation resource according to an embodiment.

As shown in FIG. 11, in the third embodiment, the transmission regulation resource is a completely blank subframe in which all the downlink radio signals are not transmitted. That is, in the completely blank subframe, neither the downlink user data, nor a control channel, a physical signal, and system information are not transmitted.

In an embodiment, the eNB 200 #1 sets, as the completely blank subframe, some downlink subframes of a plurality of downlink subframes. The UE 100 measures the cell-specific reference signal (CRS) of the eNB 200 #2 (cell #2), in the completely blank subframe. It is noted that the cell-specific reference signal (CRS) of the eNB 200 #2 (cell #2) may be a CSI reference signal transmitted from the eNB 200 #2 (cell #2), hereinafter, the same applies.

The other operations are similar to those in an embodiment. That is, the “ABS” in an embodiment may be replaced by the “completely blank subframe”.

### Communication Control Method According to an Embodiment

A communication control method according to an embodiment will be described, below.

The communication control method according to an embodiment utilizes, instead of utilizing the measurement report, a radio link failure (RLF) report. Upon detection of a radio problem in an RRC connected state, the UE 100 activates a timer T1, and if a radio link is not recovered all the while the timer T1 is activated, detects an RLF at the time of expiry of the timer T1. In some embodiments, the detection of a radio problem may include detection of loss in reception quality of a signal transmitted from the eNB 200 #1 (cell #1) or detection of the UE 100 moving out of a coverage of the cell #1.

The communication control method according to an embodiment is used in an operation environment as shown in FIG. 6. The eNB 200 #1 stops the transmission in the cell #1 in a certain period of time. The certain period may be the period which the timer T1 is activated. When the UE 100 is outside the coverage of the cell #2, the UE 100 detects the RLF after an elapse of the certain period. Thereafter, when the radio link is recovered (restored, hereinafter, the same applies) after an elapse of the certain period, the UE 100 transmits a report on the RLF (RLF report) to the eNB 200 #1. The eNB 200 #1 determines on the basis of the RLF report whether or not the cell #1 is settable to the switch off mode.

Thus, the eNB 200 #1 stops the transmission in the cell #1 in a certain period. Here, when a UE 100 located inside the coverage of the cell #2, out of the UEs 100 connected to the cell #1, performs reconnection (RRC connection re-establishment) with the cell #2, the UE 100 does not detect an RLF after an elapse of the certain period. On the other hand, a UE 100 located in the coverage hole of the cell #2 (outside the coverage of the cell #2, hereinafter, the same applies), out of the UEs 100 connected to the cell #1, is not capable of performing the reconnection with the cell #2, and thus the UE 100 detects an RLF after an elapse of the certain period. In an embodiment, the eNB 200 #1 utilizes this mechanism to confirm whether or not the cell #1 is covered by the cell #2.

### Specific Operation Example According to an Embodiment

A specific operation example according to an embodiment will be described, below.

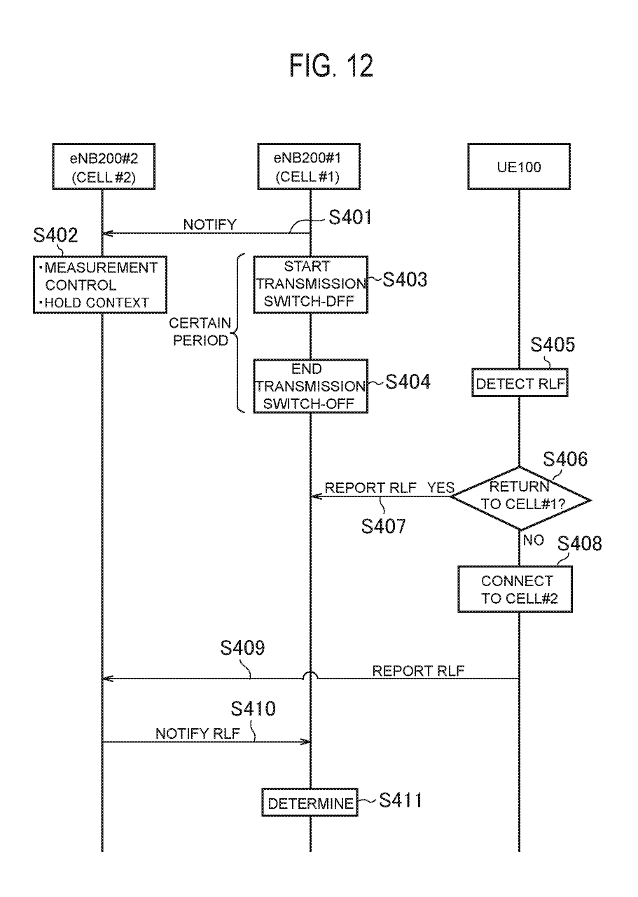

FIG. 12 is a sequence diagram showing an operation sequence according to an embodiment. The operation sequence of FIG. 12 may be not regularly performed. Alternatively, the operation sequence of FIG. 12 may be performed when a UE 100 is selected using the operation flow of FIG. 8. It is noted that in FIG. 12, it is assumed that the UE 100 is a UE 100 connected to the cell #1 and is located in the coverage hole of the cell #2.

As shown in FIG. 12, in step S401, the eNB 200 #1 notifies the eNB 200 #2, from the eNB 200 #1, of a certain period during which the transmission in the cell #1 is stopped. The eNB 200 #1 may notify the eNB 200 #2 of a beginning and an expiration of the certain period of time, for example. Further, the eNB 200 #1 notifies the eNB 200 #2 of context information (UE context) of the UE 100. The UE context is utilized when the UE 100 is reconnected to the cell #2. Information on the certain period and the UE context may be an information element of the X2 message.

In step S402, the eNB 200 #2 controls a UE connected to the cell #2 so that no measurement on a reference signal (CRS) from the eNB 200 #1 (cell #1) is performed in the certain period notified from the eNB 200 #1. For example, the eNB 200 #2 transmits configuration information for excluding the cell #1 from cells to be measured, to the UE connected to the cell #2. Further, the eNB 200 #2 holds the UE context notified from the eNB 200 #1. It is noted that the UE context may include a variety of information on the setting of the UE 100. The variety of information may be information on a radio bearer set to the UE 100 and/or configuration information on the radio measurement of the UE 100.

In step S403, the eNB 200 #1 starts, at beginning of the certain period, stoppage of a transmission in the cell #1. That is, the eNB 200 #1 stops the transmission of all the downlink radio signals from the cell #1. The UE 100 connected to the cell #1 detects not being able to receive the downlink radio signal from the cell #1, and activates the timer T1.

In step S404, the eNB 200 #1 ends, at expiration of the certain period, the transmission switch-off in the cell #1. That is, the eNB 200 #1 resumes the transmission of all the downlink radio signals coming from the cell #1.

In step S405, the UE 100 detects an RLF in response to the expiry of the timer T1. The UE 100 stores information on the detected RLF.

In step S406, the UE 100 determines whether or not the radio link with the cell #1 is recovered. When the radio link with the cell #1 is recovered (step S406: YES), in step S407, the UE 100 transmits the RLF report on the detected RLF, to the cell #1 (eNB 200 #1). The RLF report includes time information (that is, a time stamp) indicating a time at which the RLF occurs.

When the radio link with the cell #1 is not recovered (step S406: NO) and when the UE 100 moves inside the coverage of the cell #2, in step S408, the UE 100 reconnects to the cell #2 (eNB 200 #2). Here, the eNB 200 #2 holds the UE context, and thus, a smooth reconnection is possible.

In step S409, the UE 100 connected to the cell #2 transmits the RLF report on the detected RLF, to the eNB 200 #2.

In step S410, the eNB 200 #2 that has received the RLF report from the UE 100 transmits a notification (RLF Indicator) including the received RLF report, to the eNB 200 #1.

In step S411, the eNB 200 #1 determines, on the basis of the RLF report received in step S407 or step S410, whether or not the cell #1 is settable to the switch off mode. Here, the eNB 200 #1 estimates whether or not a cause of the RLF is the transmission switch-off in the cell #1, on the basis of the time information (time stamp) included in the RLF report. Then, when estimating that the cause of the RLF is the transmission switch-off in the cell #1, the eNB 200 #1 determines that the cell #1 is not settable to the switch off mode.

In an embodiment, a case where the UE 100 measures the CSI-RS of the cell #2 is provided as an example. Further, in an embodiment and another embodiment, a case where the UE 100 measures the CRS of the cell #2 is provided as an example. However, in an embodiment and another embodiment, instead of the UE 100 measuring the CRS of the cell #2, the UE 100 may measure the CSI-RS of the cell #2.

The selection of the target UE (FIG. 8) according to an embodiment is not essential, and may be omitted. When the process of FIG. 8 is omitted, the eNB 200 #1 notifies all UEs 100 connected to a cell of the eNB 200 #1 (cell #1) of the transmission regulation resource, whereby all the UEs 100 may measure the reference signal transmitted from the cell #2 in the transmission regulation resource.

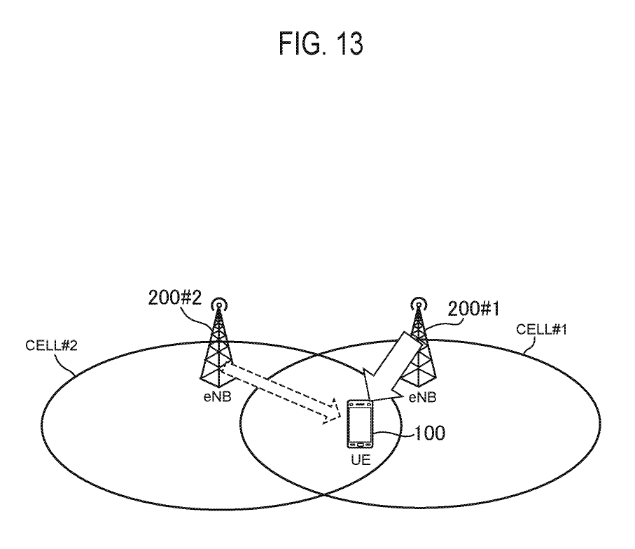

In an embodiment, as shown in FIG. 6, the cell #2 is a macro cell and the cell #1 is a small cell (a pico cell or a femto cell, for example), and the cell #1 is located inside the coverage of the cell #2. However, an embodiment of the present disclosure is not limited to such a heterogeneous network. That is, the cell #1 and the cell #2 may not only be a heterogeneous cell but also a homogeneous cell. FIG. 13 is a diagram showing an operation environment according to an embodiment. As shown in FIG. 13, both the cell #1 and the cell #2 are a macro cell. In the cell #1 and the cell #2, a part of the coverage overlaps. An embodiment of the present disclosure may be also applied to such a homogeneous network. Further, in an embodiment, the cell #1 and the cell #2 are managed by a different eNB 200. However, the cell #1 and the cell #2 may be managed by the same eNB 200.

Each of two or more embodiments may be implemented independently and separately; a part or all of the two or more embodiments may be implemented in combination. For example, out of a plurality of UEs 100 connected to a cell of the eNB 200 #1 (cell #1), the eNB 200 #1 may send the transmission regulation resource according to an embodiment to the UE 100 selected firstly, may send the transmission regulation resource according to an embodiment to the UE 100 selected secondly, and may send the transmission regulation resource according to an embodiment to the UE 100 selected thirdly. Further, a combination may be performed where an embodiment and another embodiment are simultaneously performed. For example, a combination is possible where the CSI-RS (Zero Power CSI-RS) may be set to a certain subframe, and the ABS may be set to another subframe.

In one or more embodiments, MDT (Minimization of Drive Test) is not particularly mentioned. However, the measurement report transmitted by the UE 100 may include location information indicating a geographical location of the UE 100. Such a technique is called Immediate MDT. The eNB 200 #1 that has received the measurement report including the location information may ignore, on the basis of the location information, the measurement report from the UE 100 located near the eNB 200 #1.

In one or more embodiments, the LTE system is described as an example of a mobile communication system; however, in addition to the LTE system, one or more embodiments of the present disclosure may be applied to a system other than the LTE system.

Further, in one or more embodiments, each configuration (a cell or the like) mentioned above may be one or more unless particularly the number (one or a plural) is specified.

1. A communication control method comprising:
setting at least part of downlink radio resources available in a first cell to a first resource at a first base station, wherein the first base station is configured to manage the first cell connected to a user terminal and restricts transmission in the first resource;
sending information from the first base station to the user terminal, wherein the information indicates the first resource;
performing measurement of received power and/or reception quality of a reference signal at the user terminal, wherein a second cell transmits the reference signal with using the first resource;
transmitting a measurement report from the user terminal to the first base station, wherein the measurement report includes a result of the measurement; and
determining whether or not the first cell is settable to a switch off mode, on the basis of the measurement report, at the first base station, wherein
the switch off mode includes stopping the first cell from transmitting a signal.

2. The communication control method according to claim 1, further comprising:
selecting, at the first base station, a first user terminal out of a plurality of user terminals connected to the first cell on the basis of a measurement report transmitted from each of the plurality of user terminals, wherein the first user terminal is not capable of measuring the received power and/or the reception quality; and
sending the information from the first base station to the first user terminal.

3. The communication control method according to claim 1, wherein the determining comprises:
determining that the first cell is settable to the switch off mode if the measurement report includes a measurement result that the received power and/or the reception quality of the reference signal transmitted by the second cell is equal to or greater than a predetermined value; and
determining that the first cell is not settable to the switch off mode if the measurement report does not include the measurement result that the received power and/or the reception quality of the reference signal transmitted by the second cell is equal to or greater than a predetermined value.

4. The communication control method according to claim 1, wherein
the first resource comprises a resource element used for transmission of a CSI reference signal, and
the first base station sets transmission power of the CSI reference signal in the first resource to zero.

5. The communication control method according to claim 4, further comprising:
transmitting configuration information on the first resource from the first base station to a second base station, wherein the second base station is configured to manage the second cell; and
transmitting the CSI reference signal with using the first resource from the second base station on the basis of the configuration information, wherein
the reference signal comprises the CSI reference signal.

6. The communication control method according to claim 1, wherein
the first resource comprises a blank subframe in which transmission of downlink user data is restricted, and
the reference signal comprises a cell-specific reference signal transmitted by the second cell.

7. The communication control method according to claim 1, wherein
the first resource comprises a blank subframe in which no downlink radio signal is transmitted, and
the reference signal comprises a cell-specific reference signal transmitted by the second cell.

8. A base station for managing a first cell connected to a user terminal, comprising:
a controller configured to:
set part of downlink radio resources available in the first cell to a first resource in which the base station restricts transmission; and
send information to the user terminal, wherein the information indicates the first resource; and
a receiver configured to receive, from the user terminal, a measurement report including a result of measurement of the received power and/or the reception quality of a reference signal, wherein the reference signal is transmitted by a second cell with using the first resource, wherein
the controller is further configured to determine, on the basis of the measurement report, whether or not the first cell is settable to a switch off mode, and
the switch off mode includes stopping the first cell from transmitting a signal.

9. A user terminal configured to connect to a first cell managed by a base station, comprising:
a controller configured to perform measurement of the received power and/or the reception quality of a reference signal with using a first resource if receiving information indicating the first resource from the base station, wherein the reference signal is transmitted by a second cell with using the first resource; and
a transmitter configured to transmit a measurement report to the base station, wherein the measurement report includes a result of the measurement, wherein
the first resource comprises a downlink radio resource in which the base station restricts transmission, and
the switch off mode includes stopping the first cell from transmitting a signal.

10. A communication control method, comprising:
stopping, at a first base station, a first cell from transmitting a signal for a certain period of time, wherein the first base station is configured to manage the first cell connected to a user terminal;
detecting, at the user terminal, a failure of a radio link with the first cell;
transmitting a report on the failure from the user terminal to the first base station if the radio link is recovered after an elapse of the certain period of time; and
determining, at the first base station, on the basis of the report, whether or not the first cell is settable to a switch off mode, wherein
the switch off mode includes that stopping the first cell from transmitting a signal.

11. The communication control method according to claim 10, further comprising:
transmitting a report on the failure from the user terminal to a second base station if the user terminal is connected to a second cell after an elapse of the certain period, wherein the second base station manages the second cell; and
transferring the report from the second base station to the first base station.

12. The communication control method according to claim 10, wherein
the report includes time information indicating a time at which the failure occurs, and
the determining includes determining, on the basis of the time information, that the first cell is not settable to the switch off mode if it is estimated that the failure is caused by the first cell that stops from transmitting a signal.

13. The communication control method according to claim 10, further comprising:
sending the certain period of time from the first base station to the second base station; and
causing, at the second base station, a second user terminal to restrict measurement of the received power and/or the reception quality of a reference signal in the certain period of time, wherein the second user terminal connects to the second cell, and the first cell transmits the reference signal.
